(19) United States
(12) Patent Application Publication
(10) Pub. No.: US 2022/0391028 A1
(43) Pub. Date: Dec. 8, 2022

(54) USER INPUT INTERPRETATION VIA DRIVER PARAMETERS

(71) Applicant: Microsoft Technology Licensing, LLC, Redmond, WA (US)

(72) Inventors: Yotam LIVNY, Gadera (IL); Nadav LINENBERG, Even Yehuda (IL); Amir ZYSKIND, Tel Aviv (IL)

(73) Assignee: Microsoft Technology Licensing, LLC, Redmond, WA (US)

(21) Appl. No.: 17/342,162

(22) Filed: Jun. 8, 2021

(51) Int. Cl. G06F 3/0354; G06F 3/0346; G06F 3/038; G06K 9/62

(52) U.S. Cl. CPC G06F 3/03545; G06F 3/0346; G06F 3/0383; G06K 9/6223; G06F 2203/0383

(57) ABSTRACT

Examples are disclosed that relate to interpreting user input at a computing device. One example provides a method comprising recording a plurality of interactions between a user and a computing device conducted using an input device, and extracting, from the plurality of interactions, one or more performance indicators. The method further comprises accessing a data store to obtain a predetermined profile that corresponds to the one or more performance indicators, the predetermined profile including one or more driver parameters, and implementing, at one or both of the computing device and the input device, at least one of the one or more driver parameters so as to at least affect how user input is interpreted at the computing device.

### BACKGROUND

A typical computing device may provide user-adjustable settings that affect how user input is interpreted and/or how output is provided at the computing device. Accessibility settings, for example, may enable users to adjust the sensitivity of an input device and the visibility of graphical output.

### SUMMARY

Examples are disclosed that relate to interpreting user input at a computing device. One example provides a method comprising recording a plurality of interactions between a user and a computing device conducted using an input device, and extracting, from the plurality of interactions, one or more performance indicators. The method further comprises accessing a data store to obtain a predetermined profile that corresponds to the one or more performance indicators, the predetermined profile including one or more driver parameters, and implementing, at one or both of the computing device and the input device, at least one of the one or more driver parameters so as to at least affect how user input is interpreted at the computing device.

### BRIEF DESCRIPTION OF THE DRAWINGS

FIG. 1 illustrates an example pipeline in which user interactions with a computing device are recorded to inform the interpretation of user input.

FIGS. 2A-2C illustrate example driver parameters that may be implemented at least in part at the computing device of FIG. 1.

FIGS. 3A-3D illustrate user clustering and user profile determination.

FIG. 4 shows a flowchart illustrating an example method of implementing driver parameter(s) at one or both of a computing device and an input device.

FIG. 5 shows a flowchart illustrating an example method of determining user profiles.

FIG. 6 schematically shows a block diagram of an example computing system.

### DETAILED DESCRIPTION

A typical computing device may provide user-adjustable settings that affect how user input is interpreted and/or how output is provided at the computing device. Accessibility settings, for example, may enable users to adjust the sensitivity of an input device (e.g., via selection of a cursor speed) and the visibility of graphical output (e.g., via selection of display brightness and contrast), among other potential aspects of the user experience.

In a typical example, a computing device is shipped with a set of default settings that affect the interpretation of user input and/or the provision of output. These default settings may be determined for what is conceived of as the common, prototypical user of the computing device—e.g., an idealized user whose use of the computing device is considered representative users at large. The common user may be derived from a sample of real users whose computing device interactions are “averaged” to identify how the computing device is typically used, for example. In other examples, a robotic device or other synthetic mechanism may be used to simulate human-computer interactions from which default settings are derived. Both approaches, however, fail to capture the wide diversity of users and the diverse and nuanced manners in which they interact with a computing device. Other differences in how users interact with a computing device may fail to be captured as well, such as differences arising from computing device use in different geographic regions, differing physical capability among users, and changes in how the same users interact over time due to aging or increased familiarity with the computing device. Various outcomes detrimental to the user experience may result from the use of default settings that are poorly adapted to individual users, including reduced accuracy in the supply and interpretation of user input, mismatches between user intention and outcome, and the expenditure of user effort to correct misinterpretations of user input. For some entities (e.g., computing device, operating system, firmware and/or driver vendors), these and other issues related to the user experience remain unsolved despite carrying out intensive and expensive research on human-computer interaction.

Accordingly, examples are disclosed that relate to controlling the interpretation of user input at a computing device based at least on recorded interactions between users and the computing device. Briefly, in one example, interactions between a user and the computing device conducted using an input device are recorded, and one or more performance indicators are extracted from the plurality of interactions. The performance indicator(s) may indicate physical aspects of a user such as handedness, aspects of user input such as speed and consistency, and aspects of the input device such as an orientation of a stylus. A data store is then accessed to obtain a predetermined profile that corresponds to the performance indicator(s) and includes or specifies consequent use of one or more driver parameters. The driver parameter(s) are implemented at one or both of the computing device and input device so as to affect how user input is interpreted at the computing device. As examples, the driver parameter(s) may include a cursor speed, a degree to which user input is smoothed, functions affecting how physical attributes of a user are interpreted, and other potential parameters.

By selecting driver parameters according to actual interactions between users and a computing device, the interpretation of user input—and not merely the general operation of the computing device or the manner in which output is provided—may be adapted to individual users. Various improvements to the user experience can then be realized, such as increased accuracy in the supply and interpretation of user input, reduced expenditure of user effort in computing device interactions, and increased user comfort in operating the computing device leading to more efficient human-computer interaction. These and other advantages arising from adaptive user input interpretation may be enabled by insight afforded by the performance indicators, which may reveal information about how comfortable a user is with a computing device, how a particular user profile and its driver parameters are performing and their congruence with the user, and physical attributes of the user. As such, performance indicators provide a suitable mechanism by which an appropriate user profile, among multiple user profiles, may be selected for a user, as well as a mechanism with which the performance of a selected user profile may be judged, enabling subsequent selections of other user profiles that are more adapted to the user than a previously selected user profile. Accordingly, user input interpretation and computing device operation may be optimized over time, adapting to the wide and nuanced manner in which different users interact, and adapting to changes in user demographics, user interaction paradigms, and advances in application and user interface development.

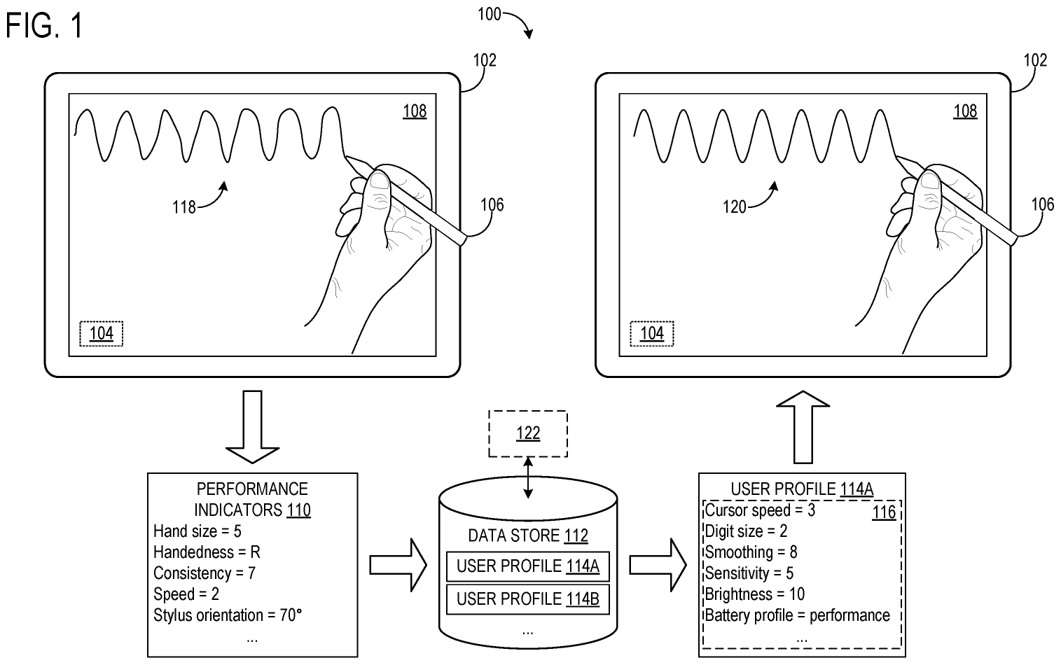

FIG. 1 illustrates an example pipeline 100 in which user interactions with a computing device 102 are recorded to inform the interpretation of user input at the computing device. In this example, computing device 102 is of the form of a mobile computing device such as a laptop, tablet, or smartphone, and includes a touch sensor schematically represented at 104. A user interacts with computing device 102 using an input device 106 in the form of a stylus, which may form a communicative link with the computing device to thereby supply user input to the computing device. As examples, stylus 106 may communicate with touch sensor 104 along an electrostatic link and/or along a radio link established between the stylus and computing device. Computing device 102 may assume any suitable form, however. For example, computing device 102 may take the form of a desktop computer, server computer, game console, or wearable computing device (e.g., a head-mounted display). Input device 106 may also assume any suitable form. For example, user interaction with computing device 102 may include the application of touch input—detected via touch sensor 104—at or proximate to a display 108 of the computing device, in which case the input device may include the user's finger(s), thumb, etc. In other examples, input device 106 may take the form of a peripheral input device such as a game controller or motion-sensing controller, mouse, keyboard, wearable input device (e.g., glove), eye-tracking device, or any other suitable type of input device.

In the depicted example, interactions between the user manipulating input device 106 and computing device 102 are recorded. Any suitable aspects of the interactions may be recorded. Example aspects include but are not limited to locations at which user input is applied, coordinates of input device 106 (e.g., relative to display 108 and/or relative to world-space), pressure applied by the input device, and/or paths, shapes, or other geometric aspects of user input. At least some of these and other potential aspects of the interactions between the user and computing device 102 may be sensed by touch sensor 104, which may output sensor data that is included in the recorded interactions. Alternatively or additionally, at least some aspects of the interactions may be sensed by a sensor device on-board input device 106 (e.g., a motion sensor), which may output sensor data that is included in the recorded interactions.

In some examples, indications of key or button actuation—whether physical keys/buttons are provided at (e.g., at input device 106) or in the form of virtual touch-sensitive keys/buttons (e.g., presented via display 108)—may be recorded. Other aspects derived from sensor data may form at least part of the recorded interactions, including but not limited to kinematic aspects (e.g., velocity, acceleration, jitter/shakiness) of input device 106 and/or the user input applied using the input device. Further, in some examples, aspects of the interaction between the user and software executing on computing device 102 may be recorded, such as an identification of applications executing on the computing device or being interacted with, buttons or other controls that are actuated, affirming and/or negating user inputs, and/or other software-related actions effected by the user.

One or more performance indicators may be extracted from the plurality of recorded interactions, as indicated at 110. The performance indicators may include physical aspects of the user manipulating input device 106, such as the (e.g., detected) size of the hand used by the user to apply input, and an identification of the hand—i.e., the detected handedness of the user. Such performance indicators may help to distinguish different users from one another, and inform how a detected area of contact applied by a hand is mapped to an area on display 108, for example. The performance indicators may include physical aspects of input device 106. For example, where input device 106 is a stylus, the performance indicators may include a tilt angle and/or azimuthal angle at which the stylus is operated. Such performance indicators may help to understand how a stylus is typically held by a user, which may be used to distinguish among different users and inform how stylus angle(s) are mapped to aspects of computing device 102, for example. Further, the performance indicators may include information regarding the user input applied by input device 106, such as information regarding the smoothness, speed, consistency, and/or repeatability of handwriting and/or other user input. In these and other examples, statistical information, such as histograms indicating the distribution of the values of a performance indicator, may be extracted from recorded interactions. Further still, the performance indicators may include information regarding user interaction with software executing on computing device 102, such as an identification of applications being interacted with, and information regarding negating user inputs applied by the user (e.g., that negate an action taken by the computing device or reverse a prior action effected by the user, such as an undo command or erasure of graphical content via a stylus). Such performance indicators may indicate general usage habits by users, user comfort with applications, and the congruence between user input and its interpretation, for example. In view of the above, the performance indicators may be extracted from sensor data collected at computing device 102 (e.g., by touch sensor 104), sensor data collected at input device 106 (e.g., by an on-board motion sensor), and/or information regarding software executed on the computing device (e.g., information provided by an operating system and/or application(s)).

Interactions between users and computing device 102 may be recorded, and performance indicators extracted from the interactions, on any suitable basis. In some examples, recording and extraction may occur as a background process executed during normal operation and use of computing device 102. As such, performance indicators, and the insight into the interaction between users and computing device 102 afforded by the performance indicators, may be obtained in a manner that is unobtrusive to the user experience. Further, in some examples, recording and/or extraction may be effected in response to one or more triggers. As one example in which computing device 102 interacts with a remote computing system described below, recording and/or extraction may be initiated upon receiving an indication from the remote computing system that a new user profile is available. In this example, recording and/or extraction may be performed in service of determining whether the new user profile is more adapted to a user of computing device 102 than another user profile currently implemented at the computing device. As another example, recording and/or extraction may be effected upon determining that previously recorded interactions and/or previously determined performance indicators are stale and should be renewed at least in part. Further, recording and/or extraction may be performed upon identifying a lack of performance indicators for a particular scenario, such as when a user utilizes a new input device, interacts with a new application, and/or engages in a new activity with computing device 102. In some examples, computing device 102 may provide user-adjustable settings that control whether and/or how recording and/or extraction are performed, and potentially how such data is shared with a remote computing system.

As noted above, performance indicators may yield insight into the interaction between users and computing device 102. As an example, performance indicators may reveal an increasing comfortability between a user and computing device 102 resulting from the implementation of a user profile, and its corresponding driver parameters, that are well adapted to the user. This comfortability may be revealed through performance indicators regarding one or more of the smoothness, speed, consistency, and repeatability of handwriting and/or other user input, as these qualities of user input tend to increase as user comfort with computing device 102 increases. Similarly, performance indicators that indicate decreasing or stagnating user performance—e.g., decreasing or stagnating smoothness, speed, consistency, and/or repeatability of user input—may lead to the conclusion that a user profile and its corresponding driver parameters are not well adapted to a user. In some examples, this conclusion may prompt the reevaluation of which user profile among multiple user profiles is most adapted to the user. Further, performance indicators may be used to detect anomalies in user interactions with computing device 102, such as deviations from expected user input or behavior. As one example, performance indicators may indicate a deviation suggesting that a new user has started to interact with computing device 102 different from a prior user. This observation may lead to implementing a different user profile for the new user, or may prompt the determination of a new user profile for the new user, as described below.

As described above, in the example depicted in FIG. 1, performance indicators 110 are extracted from a plurality of recorded interactions between the depicted user and computing device 102. A data store 112 is accessed to obtain a predetermined user profile 114 that corresponds to the performance indicators. In the depicted example, data store 112 includes a plurality of user profiles 114, among which a user profile 114A is selected due to its closest correspondence to the performance indicators among the plurality of user profiles. The correspondence between user profiles and performance indicators may be determined in any suitable manner. In some examples, each user profile 114 may include a set of performance indicators that are each compared to a respective performance indicator extracted from the recorded interactions between the depicted user and computing device 102. In some such examples, performance indicators may be weighted, for example as a function of their consistency, such that more consistent performance indicators are weighted more heavily than relatively less consistent performance indicators. In other examples, one or more extracted performance indicators, and one or more performance indicators of a user profile 114, may be combined to form combined quantities that are compared in service of selecting a particular user profile.

Each user profile 114 is associated with a respective set of driver parameters that, when implemented at computing device 102, affect how user input is interpreted at the computing device. As indicated at 116, a set of driver parameters for user profile 114A are selected based at least on the extracted performance indicators and implemented at computing device 102. FIG. 1 depicts an illustrative example of the effect that implementing user profile 114A with driver parameters that are well-adapted to a user may have on the user experience. As indicated at 118, FIG. 1 shows graphical output shown on display 108 and effected by user input applied via input device 106. This user input is interpreted according to a set of default driver parameters, and produces graphical output in the form of a sinusoidal curve. The set of default driver parameters are not personalized or otherwise adapted to the user manipulating input device 106, leading to a distorted, inconsistent, and uneven sinusoidal curve, when the user intended to draw a consistent and even sinusoidal curve.

In contrast, as indicated at 120, FIG. 1 depicts graphical output shown on display 108 that is produced by user input applied via input device 106 and interpreted according to driver parameters 116 of user profile 114A. User profile 114A and driver parameters 116 are personalized to the depicted user according to the performance indicators extracted from their interactions with computing device 102. Being adapted to this user, user profile 114A and driver parameters 116 cause the user input applied by input device 106—which in some examples may be the same as the user input that resulted in the distorted curve depicted at 118—to be interpreted in a manner that leads to graphical output at display 108 in the form of an undistorted, consistent, and smooth curve indicated at 120.

The consistency and lack of distortion exhibited by curve 120 relative to curve 118 may be achieved at least in part by implementing a driver parameter 116 in the form of a degree of user input smoothing specified by user profile 114A. The degree of smoothing may affect the extent to which user input (e.g., paths, shapes, handwriting, letters, numbers, symbols) is smoothed, and may vary among different user profiles 114. User input smoothing may help to address limitations in user motor functions, as one example. Any suitable type and number of driver parameters may be implemented and specified in user profiles 114, however. Further example driver parameters include a cursor speed, which may affect the speed at which a cursor shown on display 108 moves in response to user input; and a cursor mapping function, which may affect how user input is mapped to speed and/or other kinematic properties (e.g., acceleration) of the cursor. Adapting cursor speed and/or the cursor mapping function may increase the congruence between how input device 106 is moved and how such movement is mapped to computing device 102, for example. As such, the consistency and speed of user input may increase with increasing adaptation of these and other driver parameters.

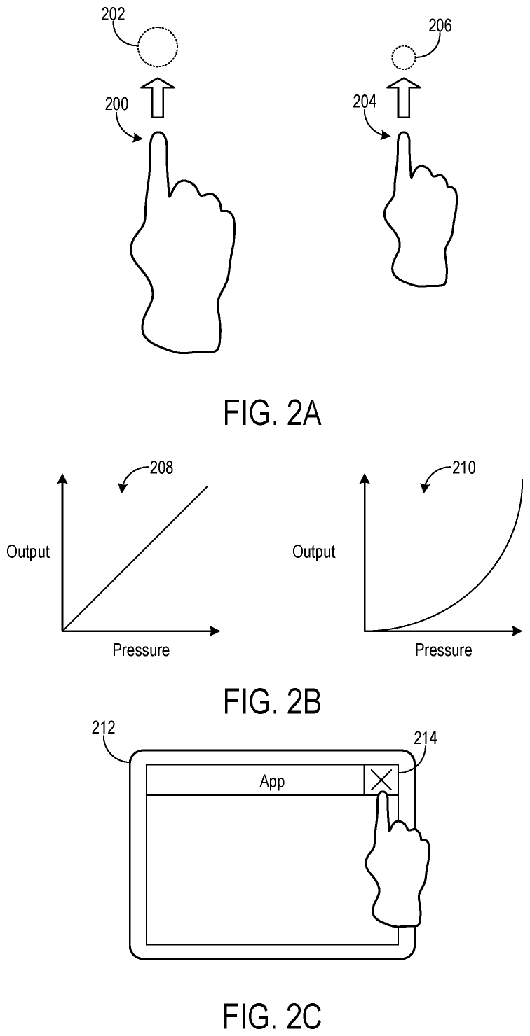

Another example driver parameter includes a digit size mapping function illustrated in FIG. 2A. In this example, the digit size mapping function may control how the detected size of a user digit (e.g., as detected by touch sensor 104) is mapped to a selection region. The user digit may contact or be in proximity to display 108, for example. A selectable control or other user-interface element (e.g., presented on display 108) may be actuated if at least a portion of the control is within a selection region. In the depicted example, the digit size mapping function varies for different detected sizes of user digits. As shown, the detected size of a user digit 200 of a user is mapped, by the digit size mapping function, to a selection region 202. In contrast, the detected size of a user digit 204—belonging to a different user—is mapped to a selection region 206 smaller than selection region 202 due to the smaller size of user digit 204 relative to user digit 200. As illustrated by this example, the digit size mapping function may help to adapt user interface selection and general interaction to the diverse range of user hand and digit sizes. As a particular example, the scenario depicted in FIG. 2 may represent adaptation for an adult hand compared to adaptation for a child hand.

Another example driver parameter includes a pressure mapping function illustrated in FIG. 2B. The depicted example shows a first pressure mapping function 208 that maps the pressure applied by an input device (e.g., the pressure applied by input device 106 to display 108 as detected by touch sensor 104) to an output. Any suitable output may be mapped to, such as a variable color or variable greyscale intensity (e.g., for a drawing application). In this example, function 208 in this example is substantially linear. In contrast, FIG. 2 also shows a second pressure mapping function 210 that maps applied pressure to an output in a non-linear manner—e.g., in a substantially quadratic manner. Function 210 may represent a pressure mapping function implemented for a user that typically applies pressure substantially greater than what is considered average, for example, and accordingly may provide greater sensitivity and granularity in output than function 208 for relatively high pressures. Other aspects may vary among different pressure mapping function. As one example, different pressure mapping functions may be selected to implement different pressure thresholds (e.g., in response to pressures applied by a user). In this example, pressures less than the threshold may not result in the application of user input, while pressures greater than or equal to the threshold may result in the application of user input, such that varying the threshold through the selection of different functions may enable pressure sensing to be adapted to diverse users that apply different levels of pressure.

Another example driver parameter includes an anomaly detection function illustrated in FIG. 2C. In the depicted example, touch input is applied by a user digit to perform a gesture in which the user digit is swiped up across the display of computing device 212. While the gesture is intended to maximize an application window, and may otherwise cause such action, the gesture concludes with the user digit overlaying a control 214 whose selection closes the application. In this example, the anomaly detection function is configured to detect this mismatch between the intent of the gesture and the outcome, and may respond by taking action(s) other than closing the application as would occur were control 214 to be actuated. Such action(s) may include but are not limited to delaying closing of the application, prompting the user to confirm their intent (e.g., through a dialog box), and/or neither closing nor maximizing the application. Accordingly, adapting the anomaly detection function may help to identify aspects of user interaction that may be improved, and reduce incongruence between user intention and outcome.

Another example driver parameter includes an input device orientation mapping function. This function may affect how orientation-related aspects of an input device are mapped to outputs at a computing device. In one example, the function may affect how one or more angles of the input device relative to a computing device surface (e.g., display 108), such as the tilt angle and azimuthal angle, are mapped to outputs. More particularly, the function may control the accuracy or granularity with which orientational aspects are mapped. For example, a first input device orientation mapping function (e.g., specified by a first user profile) may map an input device angle to angular orientations in five degree increments, while a second input device orientation mapping function (e.g., specified by a second user profile) may map an input device angle to angular orientations in ten degree increments. As another example, the input device orientation mapping function may be used to compensate for disparities between the perceived location at which a stylus or other input device applies input and the actual location at which the stylus applies input, which may result from manipulating the stylus at relatively steep angles relative to a computing device surface. In this example, differences between such perceived locations of input and actual locations of input may be observed to select or configure an input device orientation mapping function to reduce these differences. As another example, different input device orientation mapping functions may be used (e.g., by selecting different user profiles) for different user activities (e.g., tapping, drawing, writing) that tend to involve substantially different input device angles.

Another example driver parameter includes a user input sensitivity function. As an example, the user input sensitivity function may affect the sensitivity of touch input, for example through a threshold controlling whether user input is mapped to output based at least on the pressure applied by the user input, and/or a threshold controlling whether user input is mapped to output based at least on the surface area of contact made with a computing device surface. Alternatively or additionally, the sensitivity function may affect how user input is mapped to the speed of a cursor, reticle, or other user interface element, and/or the sensitivity with which controls or other selectable user interface elements are actuated (e.g., a minimum pressure, time, and/or surface area that causes element actuation). Adapting the sensitivity function may thus reduce erroneous user input and increase congruence between user intention and outcome.

As described above, the example driver parameters described above affect how user input is interpreted at the computing device. User profiles may also specify driver parameters that affect how output is provided at the computing device. As one example with resumed reference to FIG. 1, a driver parameter may include a display brightness function that affects the brightness of display 108. As one example, the display brightness function may cause an increase in the brightness of display 108 in response to identifying performance indicator(s) suggesting that a user is not accurately perceiving the location of graphical content. Adapting display brightness may increase display legibility and reduce erroneous user interactions, for example. Another example driver parameter that effects how output is provided at a computing device includes a battery consumption function. For example, the battery consumption function may affect battery consumption by the computing device by adjusting the availability of computing resources (e.g., memory, processor cores, processor clock speed). The battery consumption function may be utilized to provide higher performance and greater battery consumption for users that execute demanding applications (e.g., gaming and media applications), and to provide more constrained performance and reduced battery consumption for users that execute relatively less demanding applications (e.g., productivity applications). Adapting battery consumption may increase performance of computing device 102 and/or reduce energy consumption (without unduly affecting performance) at the computing device, for example.

The implementation of a driver parameter may occur at one or both of computing device 102 and input device 106. Where a driver parameter is implemented at computing device 102 and not input device 106, the driver parameter upon implementation may affect any suitable aspect of computing device operation, including but not limited to sensor operation (e.g., operation of touch sensor 104), computing resource usage, user input filtering or other processing, operating system operation, firmware operation, application operation, and/or output provision (e.g., graphical, tactile, audio output). Where a driver parameter is implemented at input device 106 and not computing device 102, the driver parameter upon implementation may affect any suitable aspect of input device operation, including but not limited to sensor operation (e.g., operation of an on-board motion sensor), input device resource usage, user input filter or other processing, firmware operation, and/or output provision. Where a driver parameter is implemented at both computing device 102 and input device 106, any of the above aspects of computing device and/or input device operation, or any other suitable aspect thereof, may be affected. As one example, a user profile may be implemented that causes a first driver parameter to be implemented at input device 106 (e.g., that affects sensor data acquisition and/or reporting of user input to computing device 102), and a second driver parameter to be implemented at the computing device (e.g., that affects the processing or interpretation of user input reported by the input device).

In the example depicted in FIG. 1, a set of default driver parameters are initially implemented and lead to the interpretation of user input in a manner that produces output—curve 118—that is incongruent with what the user intended—curve 120. In some examples, the default driver parameters may be specified by a default user profile implemented at computing device 102 during manufacture. Accordingly, in some such examples, the default user profile may be implemented for all users of computing device 102 and other computing devices of the same or like model upon first using the device, with a personalized user profile 114 retrieved from data store 112 being implemented at a later time.

In some examples, the default profile may be one of multiple default profiles made available at computing device 102. Upon first using computing device 102 and/or establishing a user account, the default profile may be manually selected by a user. In other examples, the default profile may be selected based at least on performance indicators extracted from recorded interactions between the user and computing device 102. In such examples, an initial set of driver parameters may be implemented (e.g., during computing device manufacture), with the set of driver parameters of the selected default profile being implemented upon extracting the performance indicators. The performance indicators—both in this example and in other examples described herein—may be extracted during normal use of computing device 102, and/or as part of a user activity provided by the computing device for the purpose of obtaining performance indicators.

In some examples, the default driver parameters may be implemented without a default user profile. In such examples, a user profile 114 may be selected from data store 112 by comparing one or more performance indicators 110 to corresponding performance indicators specified by or associated with the user profiles. A particular user profile, which in this example is user profile 114A, found to have the closest correspondence among the user profiles 114 to performance indicators 110 may be selected and its driver parameters implemented. The correspondence between performance indicators may be determined in any suitable manner. As noted above, each performance indicator extracted from recorded interactions may be compared with a corresponding performance indicator in user profiles 114, which in some examples may include weighting one or more performance indicators. Further, in some examples, comparison of performance indicators may include evaluating statistical information (e.g., distributional information, deviational information) and/or noise of a performance indicator. In such examples, a performance indicator having relatively persistent values may be considered more significant in the performance indicator comparison process and accordingly may be weighted higher than another performance indicator whose values are less persistent.

In examples in which the selection of a user profile 114 involves the comparison of a user profile (e.g., a default user profile) to the user profiles in data store 112, the similarity of the user of computing device 102 and other user(s) associated with the user profiles in the data store may be evaluated. This similarity evaluation may involve the comparison of performance indicator(s) and/or other information, such as application metadata and user information (e.g., biographical and/or biometric information, organizational status, subscription information, access privileges, information regarding application usage, sensor data). A user profile 114 may be determined to correspond to performance indicators based at least on identifying such similarity between the user of computing device 102 and one or more other users to which the user profile is assigned.

In some examples, data store 112 may be local to and maintained at least in part by computing device 102. In such examples, user profiles 114 may be downloaded from a remote computing system that creates user profiles based at least on recorded interactions between a sample of users and computing devices, as described below. In response to any suitable condition triggering the selection of a user profile 114 from data store 112, computing device 102 may evaluate the correspondence between performance indicators extracted from recorded interactions between a user and the computing device, and select a user profile with the highest correspondence.

In other examples, data store 112 may be a remote data store hosted by a remote computing system 122. In such examples, and in response to any suitable condition triggering the selection of a user profile 114 from data store 112, computing device 102 may transmit (e.g., via a suitable network connection) performance indicator(s) extracted from recorded interactions between a user and the computing device to remote computing system 122. Remote computing system 122 may then determine the correspondence between the performance indicator(s) and one or more user profiles 114, and/or the similarity among the user of computing device 102 and users associated with the user profiles, and based at least on the correspondence and/or similarity select a user profile. Computing device 102 may download the selected user profile 114 and cause its corresponding driver parameter(s) to be implemented. It will be understood, however, that in examples in which data store 112 is remotely hosted, computing device 102 may maintain a local data store at which user profiles 114 downloaded from remote computing system 122 are stored.

Any suitable trigger may cause the evaluation of user profiles 114 based at least on performance indicators provided by computing device 102. As examples, a user of computing device 102 may manually issue a request causing the evaluation of user profiles 114, and/or the computing device may automatically issue a request causing such evaluation (e.g., upon expiration of a timer, upon identifying performance indicator(s) that indicate poor user performance in supplying input). As another example, remote computing system 122 may notify computing device 102 of the availability of a new user profile 114, which may prompt the suitability of the new user profile to be evaluated. In another example, remote computing system 122 may notify computing device 102 that a new user profile 114 has a higher correspondence to performance indicator(s) received from the computing device than a user profile currently implemented at the computing device, upon which the computing device may download and cause the new user profile to be implemented. It will be understood that, in some examples, an evaluation of user profiles 114 in data store 112 may reveal that a user profile currently implemented at computing device 102 is more suitable than the user profiles in the data store. In these examples, the currently implemented user profile may continue to be implemented.

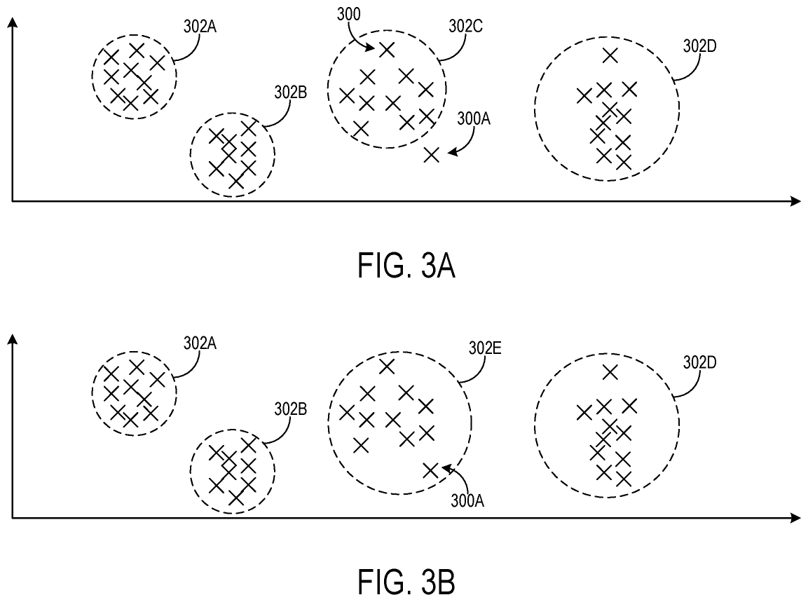

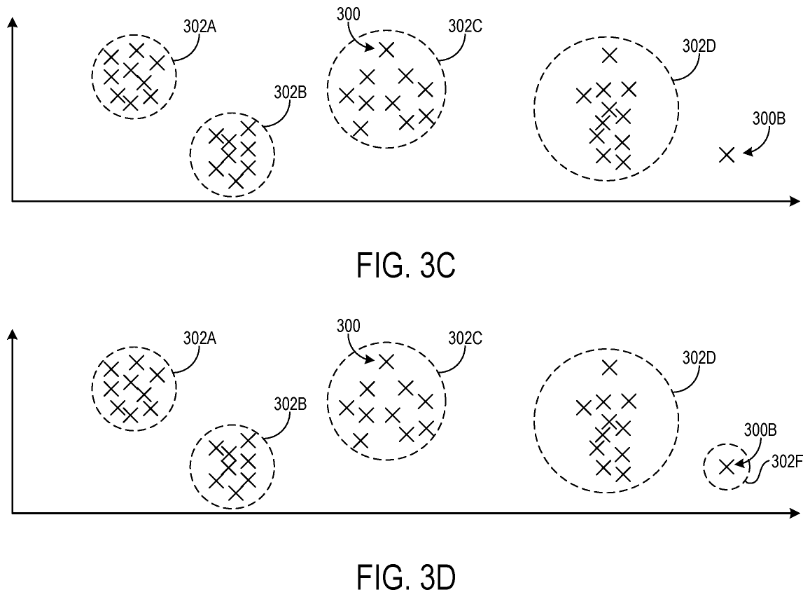

As described above, in examples in which data store 112 is remotely hosted by remote computing system 122, the remote computing system may create user profiles 114 based at least on a sample of users and their interactions with computing devices. FIG. 3A illustrates one example approach to sampling user interactions and building user profiles. In this example, a plurality of users (e.g., user 300) is plotted in two-dimensional coordinate space, for example as a function of two different performance indicators that may form respective axes of the depicted coordinate space. It will be understood, however, that any suitable number of performance indictors may be recorded for each user. Where three or more performance indicators are associated with the users, the graph depicted in FIG. 3A plots users as a function of two performance indicators for the purpose of clarity.

In this example, performance indicators for the plurality of users are extracted from recorded interactions between the users and associated computing devices, and used to group users in the form of clusters 302. A remote computing system (e.g., remote from client computing devices that request user profiles) may then determine a respective user profile for each cluster 302, with each user profile including one or more driver parameters selected based at least on the performance indicators associated with the users in the corresponding cluster. The remote computing system may store the user profiles in a data store (e.g., data store 112), for example. In response to receiving a request for a user profile on behalf of a selected user, the remote computing system may identify a user profile that corresponds to the selected user (e.g., based at least on the correspondence among performance indicators and/or user similarity) and send the user profile to a computing device associated with the selected user. In some examples, the remote computing system may determine the distance (e.g., in terms of performance indicators) between the selected user and other clustered users to select a user profile for the selected user.

Clusters 302 may be determined in any suitable manner. In some examples, users for which performance indicators are obtained may be clustered in a manner that balances cluster number and cluster coverage. As examples, a Gaussian mixture model or k-means clustering may be used to cluster users. Further, in some examples, data other than performance indicators may be used in the clustering process. As one example, users may provide feedback regarding the user experience in the form of scores, which may be correlated with their performance indicators. In this way, user perception may factor into the user profile creation and selection process, where negative user perceptions resulting from a particular user profile may reduce the likelihood of that user profile being selected, and where positive user perceptions resulting from a particular user profile may increase the likelihood of that user profile being selected.

In some examples, the remote computing system may identify a new user outside of any cluster 302. Being outside of any cluster 302, a user profile may not exist that is suitable or adapted to the new user. Accordingly, the remote computing system may expand a selected cluster 302 to include the new user, and may adjust a user profile, associated with the selected cluster, based at least on the expansion of the selected cluster. As an example, a new user 300A may be identified as being outside of any cluster 302 (e.g., based at least on the distance between the new user and the clusters and/or user(s) therein). As a result, the closest cluster—cluster 302C—to new user 300A is expanded to include the new user, resulting in an expanded cluster 302E shown in FIG. 3B.

In other examples, the remote computing system may identify a new user outside of any cluster 302 and group the new user into a new cluster. FIGS. 3C-3D illustrate one such example in which a new user 300B is identified as being outside of any cluster 302. In response to this identification, new user 300B is grouped into a new cluster 302F created for the new user, and a new user profile is determined for the new cluster. The new user profile may be created with driver parameters that are adapted to performance indicators extracted from interactions between new user 300B and computing device(s), for example. Alternatively or additionally, driver parameters from other cluster(s) 302 (e.g., one or more adjacent clusters) may be imported into the new user profile, either without modification or with modification to adapt the parameters to the new user profile and new user 300B. In view of the above, performance indicators may functionally provide a feed forward component for the purpose of selecting user profiles, and provide a feedback component for the purpose of indicating the performance of a selected user profile and its driver parameters. This process may be performed to any suitable degree of iteration, enabling the iterative adaptation of computing device operation to users.

It will be understood that user profiles may be provided at any suitable level of granularity. In some examples, different user profiles may be provided—e.g., for the same user—for different applications, enabling computing device operation to be adapted to different applications and the types of interactions they involve. A new user profile may be created in response to the release of a new application, as one particular example. Further, different user profiles may be provided—e.g., for the same user—for different user activities (e.g., handwriting, inking, drawing, gaming, hovering, gesturing) and/or for different geographic regions. Further still, different user profiles may be provided—e.g., for the same user—for different input devices. As one example, a first user profile for a user may be provided for interactions carried out with a stylus, which a second user profile for the user may be provided for interactions carried out with a user digit that applies touch input. As such, multiple user profiles may be provided for the same user. It will thus be understood that as used herein “user profile” and “predetermined profile” may refer to one of multiple user profiles assigned to the same user, and that multiple user profiles assigned to the same user may differ in any suitable aspect (e.g., be adapted for different input devices, activities, applications, interaction paradigms). Further, in some examples, multiple user profiles may be implemented simultaneously at a computing device—for example, a first user profile may be implemented for a first user interacting with the computing device, and a second user profile may be implemented for a second user interacting with the computing device. The first and second users may use different input devices, or may share a common input device (e.g., use different portions of a common keyboard).

In further examples, an option may be provided for a user to switch user profiles (e.g., during a use session) using performance indicators recently collected or collected on-the-fly. This option may enable a computing device to adapt to changes made while the user is working, such as changes occurring during a collaborative meeting, or changes arising from the user switching applications. Still further, in some examples, there may exist an inability to identify a predetermined user profile (e.g., among user profiles 114 stored at data store 112) within a threshold similarity to a user and/or user profile being used by the user. In such examples, the most similar predetermined user profile may nevertheless be selected and implemented. This implementation may be accompanied by a request (e.g., from a computing device operated by the user to remote computing system 122) to generate a new user profile (e.g., one that is within the threshold similarity and corresponds more closely than the predetermined user profile) for the user based at least on performance indicators associated with the user. Generally, support for the request and generation of new user profiles may be provided in this or in any other suitable manner. In this way, online profile management and coverage may be provided.

It will be understood that user profiles may be maintained—locally at an end user computing device and/or remotely at a remote computing system—in any suitable manner. In some examples, an existing user profile may be removed (e.g., deleted) if the user profile exhibits insufficient use or coverage of users. Where user profiles are maintained at a local data store, a predetermined number of user profiles may be stored and selectively added/removed according to a first-in-first-out policy, or any other suitable policy.

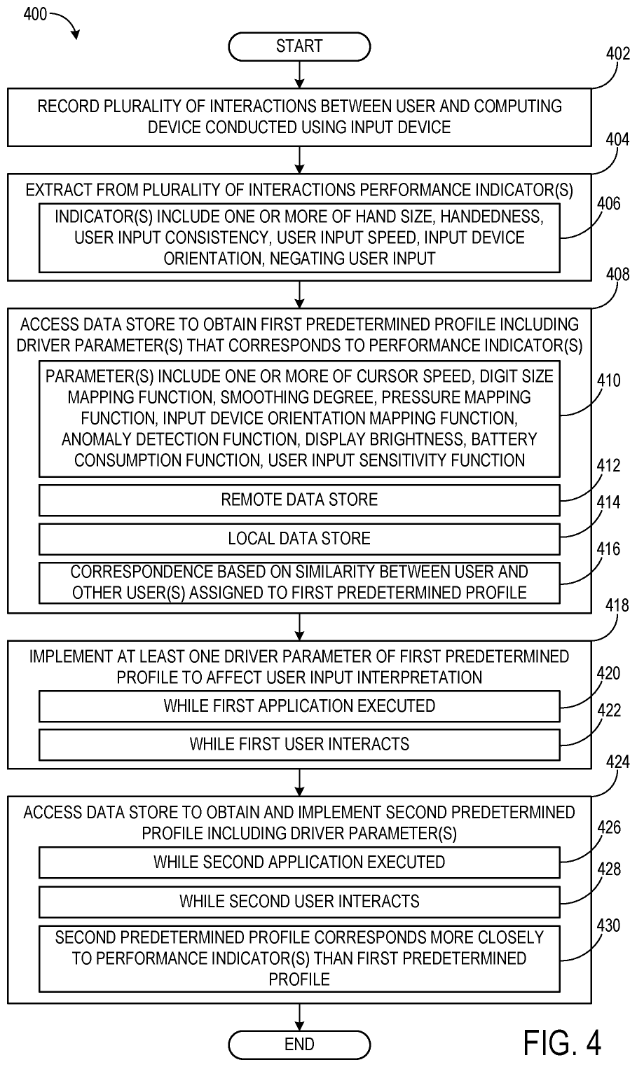

FIG. 4 shows a flowchart illustrating an example method 400 of implementing driver parameter(s) at one or both of a computing device and an input device. Method 400 may be implemented at computing device 102, for example, or in part at the computing device and in part at remote computing system 122.

At 402, method 400 includes recording a plurality of interactions between a user and a computing device conducted using an input device. At 404, method 400 includes extracting, from the plurality of interactions, one or more performance indicators. The performance indicators may include 406 one or more of a size of a hand of the user, a handedness of the user, a consistency of user input, a speed of user input, an orientation of the input device relative to the computing device, and a negating user input.

At 408, method 400 includes accessing a data store to obtain a predetermined profile that corresponds to the one or more performance indicators, the predetermined profile including one or more driver parameters. The driver parameter(s) may include 410 one or more of a cursor speed, a digit size mapping function, a degree of user input smoothing, a pressure mapping function, an input device orientation mapping function, an anomaly detection function, a display brightness, a battery consumption function, and a user input sensitivity function. In some examples, the data store may be a remote data store 412 (e.g., remotely hosted from the computing device by a remote computing system). In other examples, the data store may be a local data store 414 (e.g., maintained by the computing device). The correspondence may be based 416 at least on identifying a similarity of the user to one or more other users to which the predetermined profile is assigned.

At 418, method 400 includes implementing, at one or both of the computing device and the input device, at least one of the one or more driver parameters so as to at least affect how user input is interpreted at the computing device. The at least one driver parameter may be implemented while 420 a first application is executed on the computing device. The at least one driver parameter may be implemented while 422 a first user interacts with the computing device.

At 424, method 400 includes accessing a data store to obtain and implement a second predetermined profile including one or more driver parameters. At least one driver parameter of the second predetermined profile may be implemented while 426 a second application is executed on the computing device. At least one driver parameter of the second predetermined profile may be implemented while 428 a second user interacts with the computing device. The second predetermined profile may correspond 430 more closely to the performance indicators than the first predetermined profile. Providing user profiles for different applications may enable user interaction to be adapted to those applications, which in turn may reduce erroneous user inputs and increase the speed and consistency of user interactions, for example.

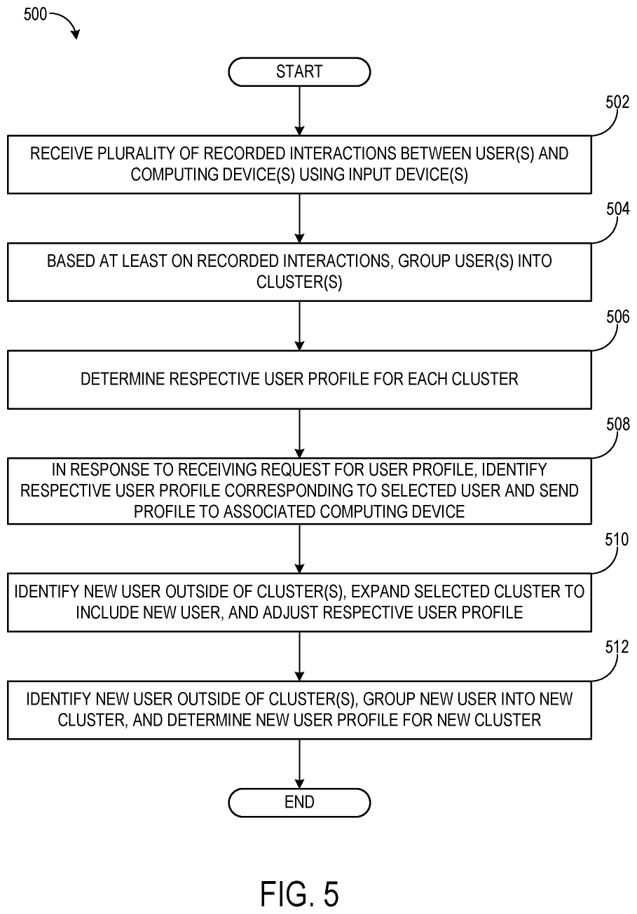

FIG. 5 shows a flowchart illustrating an example method 500 of determining user profiles. Method 500 may be implemented at remote computing system 122, for example.

At 502, method 500 includes receiving a plurality of recorded interactions between one or more users and one or more computing devices conducted using one or more input devices. At 504, method 500 includes, based at least on the plurality of recorded interactions, grouping the one or more users into one or more clusters. At 506, method 500 includes determining a respective user profile for each of the one or more clusters, each respective user profile including one or more driver parameters that when implemented at a computing device affect how user input is interpreted at the computing device. At 508, method 500 includes, in response to receiving a request for a user profile on behalf of a selected user, identifying a respective user profile that corresponds to the selected user and sending the respective user profile to a computing device associated with the selected user.

At 510, method 500 includes identifying a new user outside of the one or more clusters, expanding a selected cluster to include the new user, and adjusting a respective user profile based at least on expanding the selected cluster. At 512, method 500 includes identifying a new user outside of the one or more clusters, grouping the new user into a new cluster, and determining a new user profile for the new cluster.

The examples described herein may enable the adaptation of computing device operation to individual users across a wide variety of interaction paradigms. Various improvements to the user experience may result, including greater accuracy in the supply and interpretation of user input, and greater congruence between user intention and outcome. In some examples, the process of creating, maintaining, and providing user profiles may be offloaded from end user computing devices to a remote computing system, enabling a transparent and computationally efficient mechanism of adapting device operation to end users. Further, user profile maintenance may remain responsive to changes and updates, enabling the continued and iterative adaptation of computing device operation, for example in the presence of changes in user behavior and ability, updates to applications and releases of new applications, and new interaction paradigms and input devices.

In some embodiments, the methods and processes described herein may be tied to a computing system of one or more computing devices. In particular, such methods and processes may be implemented as a computer-application program or service, an application-programming interface (API), a library, and/or other computer-program product.

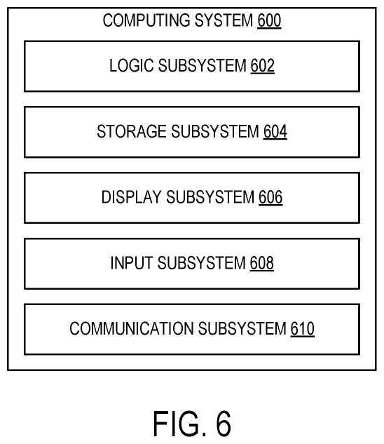

FIG. 6 schematically shows a non-limiting embodiment of a computing system 600 that can enact one or more of the methods and processes described above. Computing system 600 is shown in simplified form. Computing system 600 may take the form of one or more personal computers, server computers, tablet computers, home-entertainment computers, network computing devices, gaming devices, mobile computing devices, mobile communication devices (e.g., smart phone), and/or other computing devices.

Computing system 600 includes a logic subsystem 602 and a storage subsystem 604. Computing system 600 may optionally include a display subsystem 606, input subsystem 608, communication subsystem 610, and/or other components not shown in FIG. 6.

Logic subsystem 602 includes one or more physical devices configured to execute instructions. For example, the logic subsystem may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic subsystem may include one or more processors configured to execute software instructions. Additionally or alternatively, the logic subsystem may include one or more hardware or firmware logic machines configured to execute hardware or firmware instructions. Processors of the logic subsystem may be single-core or multi-core, and the instructions executed thereon may be configured for sequential, parallel, and/or distributed processing. Individual components of the logic subsystem optionally may be distributed among two or more separate devices, which may be remotely located and/or configured for coordinated processing. Aspects of the logic subsystem may be virtualized and executed by remotely accessible, networked computing devices configured in a cloud-computing configuration.

Storage subsystem 604 includes one or more physical devices configured to hold instructions executable by the logic subsystem to implement the methods and processes described herein. When such methods and processes are implemented, the state of storage subsystem 604 may be transformed—e.g., to hold different data.

Storage subsystem 604 may include removable and/or built-in devices. Storage subsystem 604 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage subsystem 604 may include volatile, nonvolatile, dynamic, static, read/write, read-only, random-access, sequential-access, location-addressable, file-addressable, and/or content-addressable devices.

It will be appreciated that storage subsystem 604 includes one or more physical devices. However, aspects of the instructions described herein alternatively may be propagated by a communication medium (e.g., an electromagnetic signal, an optical signal, etc.) that is not held by a physical device for a finite duration.

Aspects of logic subsystem 602 and storage subsystem 604 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 600 implemented to perform a particular function. In some cases, a module, program, or engine may be instantiated via logic subsystem 602 executing instructions held by storage subsystem 604. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

It will be appreciated that a “service”, as used herein, is an application program executable across multiple user sessions. A service may be available to one or more system components, programs, and/or other services. In some implementations, a service may run on one or more server-computing devices.

When included, display subsystem 606 may be used to present a visual representation of data held by storage subsystem 604. This visual representation may take the form of a graphical user interface (GUI). As the herein described methods and processes change the data held by the storage subsystem, and thus transform the state of the storage subsystem, the state of display subsystem 606 may likewise be transformed to visually represent changes in the underlying data. Display subsystem 606 may include one or more display devices utilizing virtually any type of technology. Such display devices may be combined with logic subsystem 602 and/or storage subsystem 604 in a shared enclosure, or such display devices may be peripheral display devices.

When included, input subsystem 608 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 610 may be configured to communicatively couple computing system 600 with one or more other computing devices. Communication subsystem 610 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 600 to send and/or receive messages to and/or from other devices via a network such as the Internet.

Another example provides a method, comprising recording a plurality of interactions between a user and a computing device conducted using an input device, extracting, from the plurality of interactions, one or more performance indicators, accessing a data store to obtain a predetermined profile that corresponds to the one or more performance indicators, the predetermined profile including one or more driver parameters, and implementing, at one or both of the computing device and the input device, at least one of the one or more driver parameters so as to at least affect how user input is interpreted at the computing device. In some such examples, the one or more performance indicators include one or more of a size of a hand of the user, a handedness of the user, a consistency of user input, a speed of user input, an orientation of the input device relative to the computing device, and a negating user input. In some such examples, the one or more driver parameters include one or more of a cursor speed, a digit size mapping function, a degree of user input smoothing, a pressure mapping function, an input device orientation mapping function, an anomaly detection function, a display brightness, a battery consumption function, a user input sensitivity function. In some such examples, the predetermined profile is a first predetermined profile, and the method alternatively or additionally comprises implementing the at least one driver parameter of the first predetermined profile while a first application is executed on the computing device, and implementing at least one driver parameter of a second predetermined profile while a second application is executed on the computing device. In some such examples, the predetermined profile is a first predetermined profile and the user is a first user, and the method alternatively or additionally comprises implementing at least one driver parameter of a second predetermined profile while a second user interacts with the computing device. In some such examples, the predetermined profile is a first predetermined profile and the input device is a stylus, and the method alternatively or additionally comprises implementing at least one driver parameter of a second predetermined profile in response to detecting a user interaction with the computing device conducted using a user digit. In some such examples, the predetermined profile is a first predetermined profile, and the method alternatively or additionally comprises accessing the data store to obtain a second predetermined profile that corresponds more closely to the one or more performance indicators than the first predetermined profile, and implementing at least one driver parameter of the second predetermined profile. In some such examples, the data store is a remote data store hosted by a remote computing system. In some such examples, the predetermined profile is determined as corresponding to the one or more performance indicators based at least on identifying a similarity of the user to one or more other users to which the predetermined profile is assigned.

Another example provides a computing device, comprising a logic subsystem, and a storage subsystem comprising instructions executable by the logic subsystem to record a plurality of interactions between a user and the computing device conducted using an input device, extract, from the plurality of interactions, one or more performance indicators, access a data store to obtain a predetermined profile that corresponds to the one or more performance indicators, the predetermined profile including one or more driver parameters, and implement, at one or both of the computing device and the input device, at least one of the one or more driver parameters so as to at least affect how user input is interpreted at the computing device. In some such examples, the one or more performance indicators include one or more of a size of a hand of the user, a handedness of the user, a consistency of user input, a speed of user input, an orientation of the input device relative to the computing device, and a negating user input. In some such examples, the one or more driver parameters include one or more of a cursor speed, a digit size mapping function, a degree of user input smoothing, a pressure mapping function, an input device orientation mapping function, an anomaly detection function, a display brightness, a battery consumption function, a user input sensitivity function. In some such examples, the predetermined profile is a first predetermined profile, and the method alternatively or additionally comprises implementing the at least one driver parameter of the first predetermined profile while a first application is executed on the computing device, and implementing at least one driver parameter of a second predetermined profile while a second application is executed on the computing device. In some such examples, the predetermined profile is a first predetermined profile and the user is a first user, and the method alternatively or additionally comprises implementing at least one driver parameter of a second predetermined profile while a second user interacts with the computing device. In some such examples, the predetermined profile is a first predetermined profile and the input device is a stylus, and the method alternatively or additionally comprises implementing at least one driver parameter of a second predetermined profile in response to detecting a user interaction with the computing device conducted using a user digit. In some such examples, the predetermined profile is a first predetermined profile, and the method alternatively or additionally comprises accessing the data store to obtain a second predetermined profile that corresponds more closely to the one or more performance indicators than the first predetermined profile, and implementing at least one driver parameter of the second predetermined profile. In some such examples, the predetermined profile is determined as corresponding to the one or more performance indicators based at least on identifying a similarity of the user to one or more other users to which the predetermined profile is assigned.

Another example provides a computing system, comprising a logic subsystem, and a storage subsystem comprising instructions executable by the logic subsystem to receive a plurality of recorded interactions between one or more users and one or more computing devices conducted using one or more input devices, based at least on the plurality of recorded interactions, group the one or more users into one or more clusters, determine a respective user profile for each of the one or more clusters, each respective user profile including one or more driver parameters that when implemented at a computing device at least affect how user input is interpreted at the computing device, and in response to receiving a request for a user profile on behalf of a selected user, identify a respective user profile that corresponds to the selected user and send the respective user profile to a computing device associated with the selected user. In some such examples, the computing system further comprises instructions executable to identify a new user outside of the one or more clusters, expand a selected cluster to include the new user, and adjust a respective user profile based at least on expanding the selected cluster. In some such examples, the computing system alternatively or additionally comprises instructions executable to identify a new user outside of the one or more clusters, group the new user into a new cluster, and determine a new user profile for the new cluster.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A method, comprising:
recording a plurality of interactions between a user and a computing device conducted using an input device;
extracting, from the plurality of interactions, one or more performance indicators, wherein each of the one or more performance indicators represents a physical aspect of a user input;
accessing a data store to select a predetermined user class profile to apply for the user, wherein the predetermined user class profile represents user interaction behavior of a plurality of users, and the predetermined user class profile is selected from among a plurality of profiles based upon a determination that the predetermined user class profile has a closest correspondence to the one or more performance indicators among the plurality of profiles, wherein the closest correspondence is determined based at least upon a similarity distance between the user and each of a plurality of clusters that group subsets of the plurality of users based at least upon the one or more performance indicators, the predetermined user class profile including one or more driver parameters; and
implementing, at one or both of the computing device and the input device, at least one of the one or more driver parameters so as to at least affect how user input is interpreted at the computing device.

2. The method of claim 1, where the one or more performance indicators include one or more of a size of a hand of the user, a handedness of the user, a consistency of user input, a speed of user input, an orientation of the input device relative to the computing device, and a negating user input.

3. The method of claim 1, where the one or more driver parameters include one or more of a cursor speed, a digit size mapping function, a degree of user input smoothing, a pressure mapping function, an input device orientation mapping function, an anomaly detection function, a display brightness, a battery consumption function, or a user input sensitivity function.

4. The method of claim 1, where the predetermined user class profile is a first predetermined profile, the method further comprising implementing the at least one driver parameter of the first predetermined profile while a first application is executed on the computing device, and implementing at least one driver parameter of a second predetermined profile while a second application is executed on the computing device.

5. The method of claim 1, where the predetermined user class profile is a first predetermined profile and the user is a first user, the method further comprising implementing at least one driver parameter of a second predetermined profile while a second user interacts with the computing device.

6. The method of claim 1, where the predetermined user class profile is a first predetermined profile and the input device is a stylus, the method further comprising implementing at least one driver parameter of a second predetermined profile in response to detecting a user interaction with the computing device conducted using a user digit.

7. The method of claim 1, where the predetermined user class profile is a first predetermined profile, the method further comprising accessing the data store to obtain a second predetermined profile that corresponds more closely to the one or more performance indicators than the first predetermined profile, and implementing at least one driver parameter of the second predetermined profile.

8. The method of claim 1, where the data store is a remote data store hosted by a remote computing system.

9. (canceled)

10. A computing device, comprising:
a logic subsystem; and
a storage subsystem comprising instructions executable by the logic subsystem to:
record a plurality of interactions between a user and the computing device conducted using an input device;
extract, from the plurality of interactions, one or more performance indicators, wherein each of the one or more performance indicators represents a physical aspect of a user input;
access a data store to select a predetermined user class profile to apply for the user, wherein the predetermined user class profile represents user interaction behavior of a plurality of users, and the predetermined user class profile is selected from among a plurality of profiles based upon a determination that the predetermined user class profile has a closest correspondence to the one or more performance indicators, wherein the closest correspondence is determined based at least upon a similarity distance between the user and each of a plurality of clusters that group subsets of the plurality of users based at least upon the one or more performance indicators, the predetermined user class profile including one or more driver parameters; and
implement, at one or both of the computing device and the input device, at least one of the one or more driver parameters so as to at least affect how user input is interpreted at the computing device.

11. The computing device of claim 10, where the one or more performance indicators include one or more of a size of a hand of the user, a handedness of the user, a consistency of user input, a speed of user input, an orientation of the input device relative to the computing device, and a negating user input.

12. The computing device of claim 10, where the one or more driver parameters include one or more of a cursor speed, a digit size mapping function, a degree of user input smoothing, a pressure mapping function, an input device orientation mapping function, an anomaly detection function, a display brightness, a battery consumption function, or a user input sensitivity function.

13. The computing device of claim 10, where the predetermined user class profile is a first predetermined profile, the method further comprising implementing the at least one driver parameter of the first predetermined profile while a first application is executed on the computing device, and implementing at least one driver parameter of a second predetermined profile while a second application is executed on the computing device.

14. The computing device of claim 10, where the predetermined user class profile is a first predetermined profile and the user is a first user, the method further comprising implementing at least one driver parameter of a second predetermined profile while a second user interacts with the computing device.

15. The computing device of claim 10, where the predetermined user class profile is a first predetermined profile and the input device is a stylus, the method further comprising implementing at least one driver parameter of a second predetermined profile in response to detecting a user interaction with the computing device conducted using a user digit.

16. The computing device of claim 10, where the predetermined user class profile is a first predetermined profile, the method further comprising accessing the data store to obtain a second predetermined profile that corresponds more closely to the one or more performance indicators than the first predetermined profile, and implementing at least one driver parameter of the second predetermined profile.

17. (canceled)

18. A computing system, comprising:
a logic subsystem; and
a storage subsystem comprising instructions executable by the logic subsystem to:
receive a plurality of recorded interactions between a plurality of users and one or more computing devices conducted using one or more input devices;
extract one or more performance indicators from the plurality of recorded interactions, each of the one or more performance indicators representing a physical aspect of a user input;
based at least on the one or more performance indicators, group the plurality of users into two or more clusters;
determine a respective user class profile for each of the two or more clusters, each respective user class profile including one or more driver parameters that when implemented at a computing device at least affect how user input is interpreted at the computing device; and
in response to receiving a request for a user class profile on behalf of a selected user, identify a respective user class profile for the user, wherein the user class profile for the selected user represents user interaction behavior of two or more users of the plurality of users, and the user class profile for the selected user is selected from among a plurality of profiles based upon a determination that the user class profile for the selected user has a closest correspondence to the selected user among the plurality of profiles, wherein the closest correspondence is determined based upon a similarity distance between the selected user and each of the two or more clusters, and send the respective user profile to a computing device associated with the selected user.

19. The computing system of claim 18, further comprising instructions executable to identify a new user outside of the one or more clusters, expand a selected cluster to include the new user, and adjust the respective user class profile based at least on expanding the selected cluster.

20. The computing system of claim 18, further comprising instructions executable to identify a new user outside of the one or more clusters, group the new user into a new cluster, and determine a new user class profile for the new cluster.

21. The computing system of claim 18, further comprising instructions executable to receive feedback for one or more of the plurality of users, the feedback for each user comprising a score that indicates a user perception resulting from application of the respective user class profile for a cluster including the user.

22. The computing system of claim 21, further comprising instructions executable to select the user class profile for the selected user based upon the feedback.
